(19) United States
(12) Patent Application Publication
(10) Pub. No.: US 2019/0302703 A1
(43) Pub. Date: Oct. 3, 2019

(54) Timepiece with Enhanced Antenna Arrangement

(71) Applicant: New York Standard Watch Company, LLC, Irwindale, CA (US)

(72) Inventor: Tai Wai LUK, Hong Kong (HK)

(73) Assignee: New York Standard Watch Company, LLC

(21) Appl. No.: 15/941,541

(22) Filed: Mar. 30, 2018

(51) Int. Cl. G04G 17/04; G04G 21/04

(52) U.S. Cl. CPC G04G 17/04; G04G 21/04

(57) ABSTRACT

An analog timepiece includes a main casing, a main core unit received in the main casing, a metallic main dial supported in the main casing, a time indicating mechanism connected to the main core unit for indicating time information, and an enhanced antenna arrangement. The enhanced antenna arrangement includes a RF integrated circuitry received in the main casing and electrically connected to the main core unit, a matching circuitry electrically connected to the RF integrated circuitry, and a conducting member connecting the matching circuitry and the main dial such that the main dial is to become an antenna for transmitting and receiving RF wireless signal.

### BACKGROUND OF THE PRESENT INVENTION

### Field of Invention

The present invention relates to a timepiece, and more particularly to a timepiece comprising an enhanced antenna arrangement which is capable of substantially enhancing RF transmission performance of the timepiece.

### Description of Related Arts

A conventional timepiece, such as a conventional analog quartz watch, usually comprises a main casing, a main control unit (MCU), a plurality of time indicating hands connected to the MCU, and a plurality of watch bands connected to the main casing. Some conventional timepieces, such as conventional analog watches, are equipped with Radio Frequency (RF) receiver or transceiver for receiving radio frequency signal to or from an external source. For such conventional analog watches, a RF antenna may be received in the main casing.

A common problem for the above-mentioned timepiece with RF receiver or transceiver is that the RF antenna is usually enclosed by a metallic casing and the RF signal may be severely interfered by the metallic casing. This is true for almost all frequency ranges. As a result, conventional analog timepiece with RF antenna may suffer from the problem of unstable signal reception or even no reception at all. This problem severely limits the use of RF antenna in analog timepiece because it makes conventional analog smartwatches unreliable. This situation is similar to putting to a radio inside an enclosed metallic box. In this situation, the radio may not receive radio signal properly.

As a result, there is a need to improve upon conventional analog timepiece with RF antenna so as to resolve the above-mentioned problem.

### SUMMARY OF THE PRESENT INVENTION

Certain variations of the present invention provide a timepiece comprising an enhanced antenna arrangement which is capable of substantially enhancing RF transmission performance of the timepiece.

Certain variations of the present invention provide a timepiece comprising an enhanced antenna arrangement, wherein a metallic main casing of the timepiece may be utilized as an antenna for substantially improving reception and transmission of RF signals.

Certain variations of the present invention provide a timepiece comprising an enhanced antenna arrangement which may enhance transmission and reception of a wide range of RF signals.

In one aspect of the present invention, it provides a timepiece, comprising:

a main casing;

a main core unit received in the main casing;

a main dial supported in the main casing, the main dial being configured from metallic material;

a time indicating mechanism connected to the main core unit for indicating time information; and

an enhanced antenna arrangement, which comprises:

a RF integrated circuitry received in the main casing and electrically connected to the main core unit;

a matching circuitry electrically connected to the RF integrated circuitry; and

a conducting member electrically connecting to the matching circuitry and the main dial such that the main dial is to become an antenna for transmitting and receiving RF wireless signal.

In another aspect to the present invention, it provides a timepiece, comprising:

a main casing;

a main core unit received in said main casing;

a main dial supported in said main casing, said main dial being configured from metallic material;

a time indicating mechanism connected to said main core unit for indicating time information; and

an enhanced antenna arrangement, which comprises:

a RF integrated circuitry received in said main casing and electrically connected to said main core unit;

a matching circuitry electrically connected to said RF integrated circuitry;

a conducting member having one end connecting to said matching circuity; and

a conductive panel connected to another end of said conducting member and positioned close to a bottom side of said main dial so as to form a capacitor unit by said conductive panel and said main dial, said conductive panel and said main dial being arranged to become an antenna for transmitting and receiving RF wireless signal.

This summary presented above is provided merely to introduce certain concepts and not to identify any key or essential features of the claimed subject matter.

### BRIEF DESCRIPTION OF THE DRAWINGS

FIG. 1 a perspective view of a timepiece according to a preferred embodiment of the present invention.

FIG. 2 is a schematic diagram of the timepiece according to the preferred embodiment of the present invention.

FIG. 3 is a block diagram of the timepiece according to the preferred embodiment of the present invention.

FIG. 4 is a first alternative mode of the timepiece according to the preferred embodiment of the present invention.

FIG. 5 is a second alternative mode of the timepiece according to the preferred embodiment of the present invention.

FIG. 6 is a third alternative mode of the timepiece according to the preferred embodiment of the present invention.

FIG. 7 is a block diagram of the timepiece according to the third alternative mode of the present invention.

FIG. 8 a fourth alternative mode of the timepiece according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

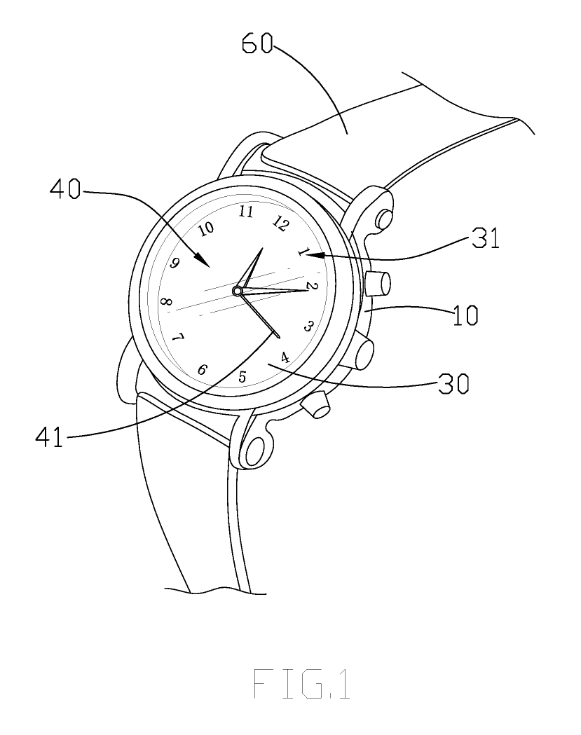

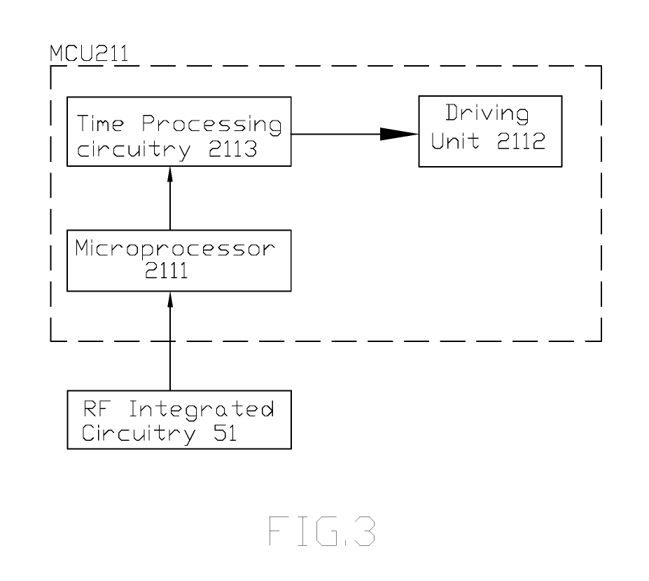

Referring to FIG. 1 to FIG. 3 of the drawings, a timepiece such as an analog watch according a first preferred embodiment of the present invention is illustrated. Broadly, the timepiece may comprise a main casing 10, a main core unit 20 received in the main casing 10, a main dial 30, at least one time indicating mechanism 40, and an enhanced antenna arrangement 50.

The main dial 30 may be supported in the main casing 10, and may be configured from metallic material.

The time indicating mechanism 40 may be connected to the main core unit 20 for indicating time information, such as hour information, minute information and second information.

The enhanced antenna arrangement 50 may comprise a Radio Frequency (RF) integrated circuitry 51, a matching circuitry 52 and a conducting member 53. The RF integrated circuitry 51 may be received in the main casing 10 and electrically connected to the main core unit 20. The matching circuitry 52 may be electrically connected to the RF integrated circuitry 51. The conducting member 53 may be electrically connected to the matching circuitry 52 and the main dial 30 such that the main dial 30 is to become an antenna for transmitting and receiving RF wireless signal.

The timepiece mentioned above may be configured as having a number of variations. For example, the timepiece may be configured as an analog watch. In this preferred embodiment of the present invention, the analog timepiece may be configured as an analog watch. Thus, the timepiece may further comprise a plurality of watch bands 60 extended from two sides of the main casing 10. Thus, the main dial 30 may have a plurality of time markings 31 while the time indicating mechanism 40 may comprise a plurality of time indicating hands 41 rotatably mounted at a position above the main casing 10.

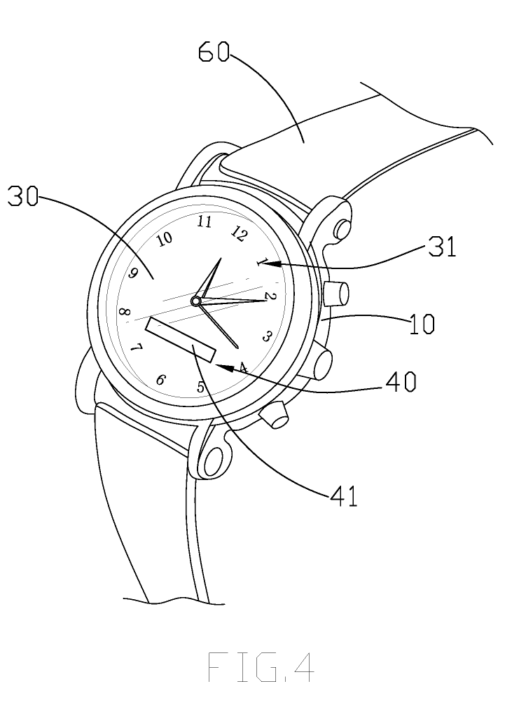

Alternatively, the timepiece may be configured as a digital watch so that the time indicating mechanism 40 may comprise a LCD 41′ display for displaying time and other information, such as hour information, minute information and/or second information, as shown in FIG. 4 of the drawings.

The term “analog” may refer to the mode of display of time by the analog timepiece of the present invention. Thus, the analog timepiece may display time information (hours, minutes and/or seconds) by at least one time indicating hand 41 rotating above the main dial 30 in an incremental manner. The main casing 10 may be configured as having a circular cross section, and may have a receiving cavity for accommodating other components of the analog timepiece. Note that other cross-sectional shapes of the main casing 10 may also be possible. This meaning of “analog” is applicable to the first preferred embodiment of the present invention as described herein.

Similarly, the term “digital” may refer to the mode of display of time by digital methods. Thus, a digital timepiece may display time information (hours, minutes and/or seconds) by a digital display 41′ (such as a LCD or a LED display) provided on the main dial 30. Yet an alternative mode is a mix of analog and digital display so that the main dial 30 may have both time indicating hands 41 and a digital display 41′, as shown in FIG. 4 of the drawings.

The main casing 10 may be configured from or made of metallic material so that it may impart metallic aesthetics appearance of the analog timepiece. At the same time, however, the metallic timepiece may interfere with wireless signal transmission as mentioned above. The present invention aims to resolve this problem. The main casing 10 may further comprise a cover 11 mounted above the main dial 30. The cover 11 may be configured from glass material or other light admissible material for allowing a user to observe the main dial 30 from an exterior of the main casing 10.

The main core unit 20 may comprise a driving core 21 received in the main casing 20. The driving core 21 may utilize one of the three driving mechanisms. First, the driving core 21 may comprise a quartz driving unit. The quartz driving unit may be configured as a conventional electronic oscillator that is regulated by a quartz crystal. Alternatively, the driving core 21 may comprise a microcontroller unit (MCU) 211 that keeps time. The MCU 211 may comprise a time processing circuitry 2113 and a driving unit 2112 such as a step motor for driving the time indicating mechanism 40. The time processing circuitry 2113 may comprise a microprocessor 2111 for processing time information.

The main dial 30 may be provided in the main casing 10 for providing the time markings 31. The time indicating mechanism 40 may be connected to the main core unit 20 in a rotatably movable manner so that the time indicating mechanism 40 may rotate on the main dial 30 in an incremental manner. The time indicating mechanism 40 may be driven to rotate so as to point to predetermined time markings 31 for indicating time information. Thus, the time markings 31 may include second markings, minutes markings, and/or hour markings. In this preferred embodiment, the main dial 30 may be configured from or made of metallic material so that the main dial 30 may act as a conductive medium for transmitting or receiving RF wireless signals.

When more than one time indicating hands 41 are utilized, a gear assembly 42 may be connected to the time indicating hands 41 so as to drive the time indicating hands 40 to incrementally rotate in predetermined intervals. For example, when three time indicating hands 40 (namely, a second indicating hand, a minute indicating hand and a hour indicating hand) are utilized, one of them may be connected to the main core unit 20 for indicating second information. The gear assembly 42 may be utilized so that when the second indicating hand has moved 60 second markings on the main dial 30, the minute indicating hand may move one minute marking on the main dial 30, and when the minute indicating hand has moved 60 minute markings, the hour indicating hand may move one hour marking on the main dial 30.

The enhanced antenna arrangement 50 may be designed to allow the analog timepiece to receive and transmit RF wireless signal effectively even though the main casing 10 is made of metallic material. The RF integrated circuitry 51 may be configured to process predetermined types of RF wireless signals. For example, the RF integrated circuitry 51 may be configured to process short-range RF wireless signal such as BLUETOOTH signals or GPS signals. The RF integrated circuitry 51 may be implemented on a Printed Circuit Board (PCB 54) received in the main casing 10. The RF integrated circuitry 51 may be electrically connected to the MCU 211 of the main core unit 20 for communicating the signals received by the RF integrated circuitry 51 with the main core unit 20.

The matching circuitry 52 may also be implemented on the PCB 54 and may be electrically connected to the RF integrated circuitry 51. The matching circuitry 52 may be configured to tune antenna impedance of the main dial 30 to a predetermined value. The matching circuitry 52 may be utilized for enhancing the effectiveness of receiving wireless transmission from an external source.

The conducting member 53 may be connected between the matching circuitry 52 and the main dial 30 so as to allow the main dial 30 to become an antenna for receiving RF wireless signals. Since the main dial 30 is configured from metallic material, when the main dial 30 is connected to the matching circuitry 52, the signal received by the main dial 30 may be transmitted to the matching circuitry 52 for processing by the MCU 211. The MCU 211 may then drive the time indicating hands 41 or the digital display 41′ to display the corresponding commands executed by the MCU 211.

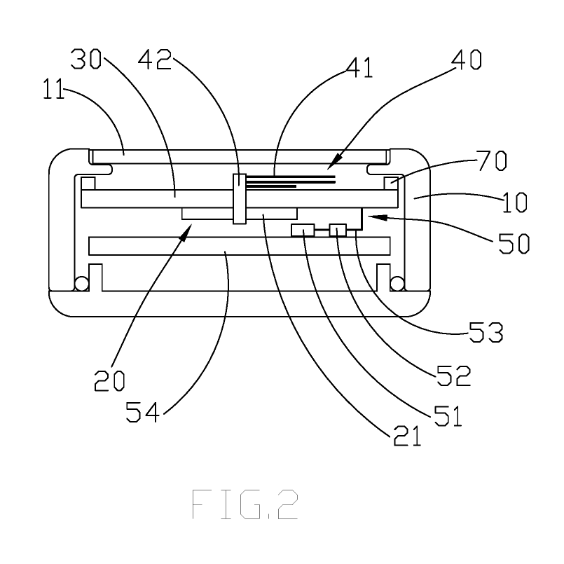

The enhanced antenna arrangement 50 may further comprise an insulating member 70 provided in the main casing 10 and positioned to insulate the main casing 10 from the main dial 30. As shown in FIG. 2 of the drawings, the insulating member 70 may be provided between the main dial 30 and the main casing 10 so as to prevent potential short circuit which may be formed between the main dial 30 and the main casing 10. The insulating member 70 may be embodied as a sealing ring, an insulating sheet, or even an insulating coating formed between the main casing 10 and the main dial 30. The purpose of the insulating member 70 is to prevent potential short circuit between the main dial 30 and the main casing 10. Equivalently, the insulating member 70 may be embodied as an insulating layer (such as an air layer) formed in the main casing 10 and positioned to insulate the main casing 10 from the main dial 30.

By transforming the main dial 30 to an antenna, the performance of transmitting and receiving RF wireless signal by the timepiece may be substantially enhanced as compared to conventional timepieces.

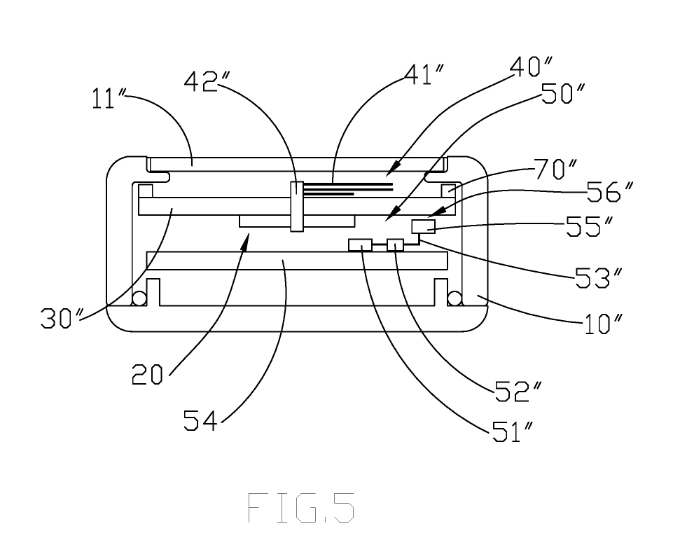

Referring to FIG. 5 of the drawings, a second alternative mode according to the preferred embodiment of the present invention is illustrated. The second alternative mode is similar to the preferred embodiment except the enhanced antenna arrangement 50″. According to the second alternative mode, the enhanced antenna arrangement 50″ may further comprise a conductive panel 55″ connected to a free end of the conducting member 53″. The conductive panel 55″ may be positioned in the main casing 10″ very close (but not touching) to the main dial 30″. In other words, the conductive panel 55″ and the main dial 30″ may form a very thin dielectric layer in between (such as air trapped in the main casing 10″) so that in effect, the conductive panel 55″ and the main dial 30″ may form a capacitor unit 56″. The main dial 30″ and the conductive panel 55″ may then be transformed to an antenna for receiving and transmitting wireless signals.

Thus, one end of the conducting member 53″ may be connected to the matching circuitry 52″ which may be connected to the RF integrated circuitry 51″. The conducting member 53″ may then extend in the main casing 10″ so that another end of the conducting member 53″ may be connected to the conductive panel 55″, which may be positioned near the main dial 30 at a bottom side thereof.

In this second alternative mode, the time indicating mechanism 40″, the time indicating hands 41″, the insulating member 70″, the gear assembly 42, and the cover 11″ may be structurally the same as those disclosed in the preferred embodiment of the present invention above.

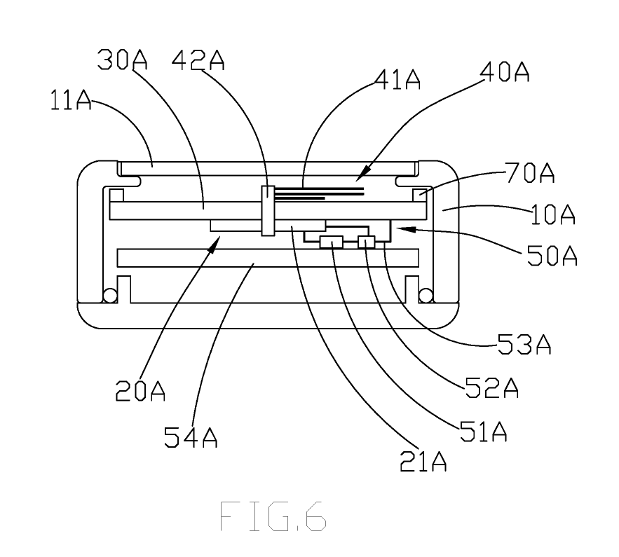

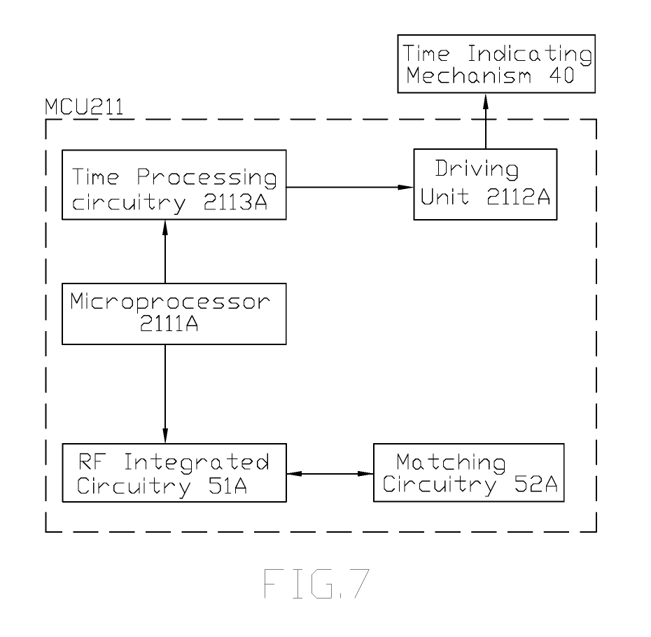

Referring to FIG. 6 and FIG. 7 of the drawings, a timepiece according to a third alternative mode of the present invention is illustrated. The third alternative mode is similar to the preferred embodiment as described above, except that the enhanced antenna arrangement 50A may be incorporated in the main core unit 20A, so that a single MCU 211A may control the operation of displaying time and processing wireless signals.

According to the third alternative mode, the main core unit 20A may comprise a driving core 21A received in the main casing 10A. The driving core 21A may comprise a microcontroller unit (MCU) 211A that keeps time. The MCU 211 may comprise a microprocessor 2111A for processing time information, a time processing circuitry 2113A electrically connected to the microprocessor 2111A, and a driving unit 2112A such as a step motor for driving the time indicating mechanism 40A which may comprise the time indicating hands 41A described above.

Moreover, the MCU 211A may further comprise an enhanced antenna arrangement 50A comprising a RF integrated circuitry 51A configured to process predetermined types of RF wireless signals. For example, the RF integrated circuitry 51A may be configured to process short-range RF wireless signal such as BLUETOOTH signals or GPS signals. The RF integrated circuitry 51A may be electrically connected to the microprocessor 2111A and may be implemented on a Printed Circuit Board (PCB 54A) received in the main casing 10A.

The enhanced antenna arrangement 50A may further comprise a matching circuitry 52A also implemented on the PCB 54A and may be electrically connected to the RF integrated circuitry 51A. The matching circuitry 52A may be configured to tune antenna impedance of the main dial 30A to a predetermined value. The matching circuitry 52A may be utilized for enhancing the effectiveness of receiving wireless transmission from an external source.

The enhanced antenna arrangement 50A may further comprise a conducting member 53A connected between the matching circuitry 52A and the main dial 30A or the driving core 21A of the main core unit 20A so as to allow the main dial 30A to become an antenna for receiving RF wireless signals. Thus, each of the driving core 21A and the main dial 30A may be at least partially configured from metallic material so that when the main dial 30A or the driving core 21A is connected to the matching circuitry 52A, the signal received by the main dial 30A or the driving core 21A may be transmitted to the matching circuitry 52A for processing by the MCU 211A through the conducting member 53A. The MCU 211A may then drive the time indicating hands 41A or the digital display 41′ to display the corresponding commands executed by the MCU 211A. The matching circuitry 52A may be electrically connected to the metallic portion of the main dial 30A or the driving core 21A.

It is worth clarifying that the difference between the preferred embodiment and the third alternative mode is that in the preferred embodiment, the MCU 211 and the enhanced antenna arrangement 50A may be separate electrical components and they do not necessarily incorporate into a single module. In the third alternative mode, the enhanced antenna arrangement 50A may be incorporated into the MCU 211A to form a single control unit for controlling time and processing wireless signals.

In this third alternative mode, the insulating member 70A, the gear assembly 42A, and the cover 11A may be structurally the same as those disclosed in the preferred embodiment of the present invention above.

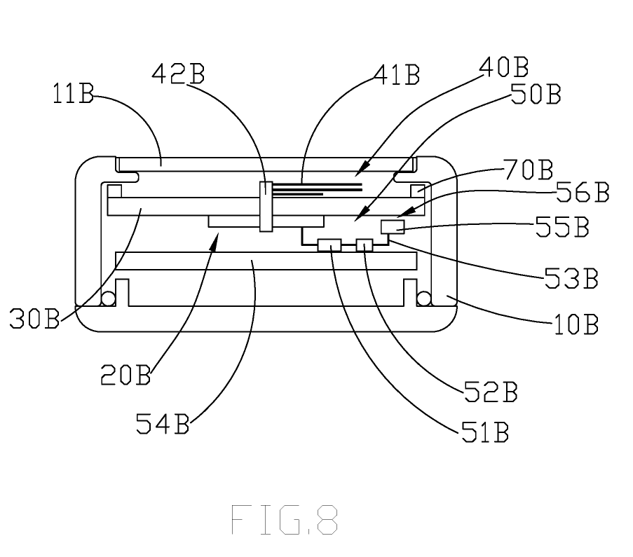

As a fourth alternative mode of the present invention, the enhanced antenna arrangement 50″ as disclosed in the second alternative mode may also be used in the third alternative mode. Thus, referring to FIG. 8 of the drawings, the enhanced antenna arrangement 50B may further comprise a conductive panel 55B connected to a free end of the conducting member 53B. The conductive panel 55B may be positioned in the main casing 10B very close (but not touching) to the main dial 30B. In other words, the conductive panel 55B and the main dial 30B may form a very thin dielectric layer in between so that in effect, the conductive panel 55B and the main dial 30B may form a capacitor unit 56B. The main dial 30B and the conductive panel 55B may then be transformed to an antenna for receiving and transmitting wireless signals.

One end of the conducting member 53B may be connected to the matching circuitry 52B which may be connected to the RF integrated circuitry 51B. The conducting member 53B may then extend in the main casing 10B so that another end of the conducting member 53B may be connected to the conductive panel 55B, which may be positioned near the main dial 30B at a bottom side thereof.

In this fourth alternative mode, the main core unit 20B, the PCB 54B, the insulating member 70B, the time indicating mechanism 40B, the time indicting hands 41B, the gear assembly 42B, and the cover 11B may be structurally the same as those disclosed in the third alternative mode above.

The present invention, while illustrated and described in terms of a preferred embodiment and several alternatives, is not limited to the particular description contained in this specification. Additional alternative or equivalent components could also be used to practice the present invention.

What is claimed is:

1. A timepiece, comprising:
a main casing;
a main core unit received in said main casing;
a main dial supported in said main casing, said main dial being configured from metallic material;
a time indicating mechanism connected to said main core unit for indicating time information; and
an enhanced antenna arrangement, which comprises:
a RF integrated circuitry received in said main casing and electrically connected to said main core unit;
a matching circuitry electrically connected to said RF integrated circuitry; and
a conducting member connecting said matching circuity and said main dial such that said main dial is to become an antenna for transmitting and receiving RF wireless signal.

2. The timepiece, as recited in claim 1, wherein said main dial has a plurality of time markings while said time indicating mechanism comprises a plurality of time indicating hands rotatably mounted at a position above said main casing.

3. The timepiece, as recited in claim 1, wherein said time indicating mechanism comprises a digital display for displaying time.

4. The timepiece, as recited in claim 2, wherein said matching circuitry is configured to tune antenna impedance of said main dial to a predetermined value.

5. The timepiece, as recited in claim 4, wherein said main core unit comprises a driving core received in said main casing, said driving core comprising a microcontroller unit which is arranged to keep time.

6. The timepiece, as recited in claim 5, wherein said main casing is configured from metallic material.

7. The timepiece, as recited in claim 6, wherein said enhanced antenna arrangement further comprises an insulating member provided in said main casing and positioned between said main dial and said main casing so as to prevent potential short circuit between said main dial and said main casing.

8. A timepiece, comprising:
a main casing;
a main core unit received in said main casing;
a main dial supported in said main casing, said main dial being configured from metallic material;
a time indicating mechanism connected to said main core unit for indicating time information; and
an enhanced antenna arrangement, which comprises:
a RF integrated circuitry received in said main casing and electrically connected to said main core unit;
a matching circuitry electrically connected to said RF integrated circuitry;
a conducting member having one end connecting to said matching circuity; and
a conductive panel connected to another end of said conducting member and positioned close to a bottom side of said main dial so as to form a capacitor unit by said conductive panel and said main dial, said conductive panel and said main dial being arranged to become an antenna for transmitting and receiving RF wireless signal.

9. The timepiece, as recited in claim 8, wherein said main dial has a plurality of time markings while said time indicating mechanism comprises a plurality of time indicating hands rotatably mounted at a position above said main casing.

10. The timepiece, as recited in claim 8, wherein said time indicating mechanism comprises a digital display for displaying time.

11. The timepiece, as recited in claim 9, wherein said main core unit comprises a driving core received in said main casing, said driving core comprising a microcontroller unit which is arranged to keep time.

12. The timepiece, as recited in claim 11, wherein said main core unit comprises a driving core received in said main casing, said driving core comprising a microcontroller unit which is arranged to keep time.

13. The timepiece, as recited in claim 12, wherein said main casing is configured from metallic material.

14. The timepiece, as recited in claim 13, wherein said enhanced antenna arrangement further comprises an insulating member provided in said main casing and positioned between said main dial and said main casing so as to prevent potential short circuit between said main dial and said main casing.

15. A timepiece, comprising:
a main casing;
a time indicating mechanism receiving in said main casing;
a main dial supported in said main casing, said main dial being configured from metallic material; and
a main core unit which is received in said main casing, and comprises:
a microcontroller unit, which comprises:
a microprocessor;
a time processing circuitry electrically connected to said microprocessor,
a driving unit electrically connected to said time processing circuitry for driving the time indicating mechanism; and
an enhanced antenna arrangement, which comprises:
a RF integrated circuitry electrically connected to said microprocessor;
a matching circuitry electrically connected to said RF integrated circuitry; and
a conducting member connecting said matching circuity and said main dial such that said main dial is to become an antenna for transmitting and receiving RF wireless signal.

16. The timepiece, as recited in claim 1, wherein said main dial has a plurality of time markings while said time indicating mechanism comprises a plurality of time indicating hands rotatably mounted at a position above said main casing.

17. The timepiece, as recited in claim 16, wherein said matching circuitry is configured to tune antenna impedance of said main dial to a predetermined value.

18. The timepiece, as recited in claim 17, wherein said main casing is configured from metallic material.

19. The timepiece, as recited in claim 18, wherein said enhanced antenna arrangement further comprises an insulating member provided in said main casing and positioned between said main dial and said main casing so as to prevent potential short circuit between said main dial and said main casing.

20. A timepiece, comprising:
a main casing;
a time indicating mechanism receiving in said main casing;
a main dial supported in said main casing, said main dial being configured from metallic material; and
a main core unit which is received in said main casing, and comprises:
a microcontroller unit, which comprises:
a microprocessor;
a time processing circuitry electrically connected to said microprocessor,
a driving unit electrically connected to said time processing circuitry for driving the time indicating mechanism; and
an enhanced antenna arrangement, which comprises:
a RF integrated circuitry electrically connected to said microprocessor;
a matching circuitry electrically connected to said RF integrated circuitry;
a conducting member having one end connecting to said matching circuity; and
a conductive panel connected to another end of said conducting member and positioned close to a bottom side of said main dial so as to form a capacitor unit by said conductive panel and said main dial, said conductive panel and said main dial being arranged to become an antenna for transmitting and receiving RF wireless signal.

21. The timepiece, as recited in claim 20, wherein said main dial has a plurality of time markings while said time indicating mechanism comprises a plurality of time indicating hands rotatably mounted at a position above said main casing.

22. The timepiece, as recited in claim 21, wherein said matching circuitry is configured to tune antenna impedance of said main dial to a predetermined value.

23. The timepiece, as recited in claim 22, wherein said main casing is configured from metallic material.

24. The timepiece, as recited in claim 23, wherein said enhanced antenna arrangement further comprises an insulating member provided in said main casing and positioned between said main dial and said main casing so as to prevent potential short circuit between said main dial and said main casing.
